(19) United States
(12) Patent Application Publication
(10) Pub. No.: US 2006/0106504 A1
(43) Pub. Date: May 18, 2006

(54) Apparatus and a system for determining compliance with parking rules by vehicle

(76) Inventor: Timothy Guy Carpenter, London (GB)

Correspondence Address: GOTTLIEB RACKMAN & REISMAN PC, 270 MADISON AVENUE, 8TH FLOOR, NEW YORK, NY, 100160601, US

(21) Appl. No.: 10/525,786

(22) PCT Filed: Aug. 27, 2003
(86) PCT No.: PCT/GB03/03716

§ 371 Date: Sep. 26, 2005

(30) Foreign Application Priority Data
Aug. 27, 2002 (GB) 02198802

(51) Int. Cl. G06F 17/00

(52) U.S. Cl. 701/1; 340/932.2

(57) ABSTRACT

In order to provide an apparatus and a system for determining compliance with parking rules by a vehicle, the apparatus (1101) comprises means for receiving a signal representing a location selected from a plurality of locations, rule storage means (1102, 1103) for storing parking rules relating to the plurality of locations, means for obtaining from the rule storage means (1102, 1103) a rule relating to the selected location, means for determining if a vehicle parked at the selected location complies with the rule and means for transmitting a compliance signal representing the compliance determination. The apparatus can be used in conjunction with vehicle observing means (1400) to determine if a vehicle is incorrectly parked. The mobile vehicle observing means (1400) comprises camera means (1401) for obtaining a digital image of at least the registration plate of the vehicle, position detecting means (1409) for detecting the position of the mobile device, range determining means (1402) for finding the range of the vehicle from the mobile device, direction determining means (1404, 1405) for finding the direction of the vehicle with respect to the mobile device and transmitting means (1412), (1407) for transmitting signals representing the image of the vehicle and direction and distance of the vehicle from the mobile device to the apparatus (1101).

The present invention relates to an apparatus and a system for determining compliance with parking rules by a vehicle, and also to a mobile vehicle observing means for providing data for determining the position of a parked vehicle and a device for obtaining parking information for a vehicle.

In modern towns and cities, the management of parking facilities in streets is a complex but essential task.

In order to provide clear streets allowing for good flow of traffic and buses during busy periods whilst allowing adequate on-street parking for residents and visitors, it is normal to have complex sets of rules about where parking is allowed, when and under what conditions. Some routes are more or less permanently used by large volumes of traffic and stopping and parking are not permitted. Such routes are typically controlled by police or other authorities in order to prevent illegal stopping and parking. On some routes, parking is permitted at certain times of day and these are normally controlled by wardens who are employed by or contracted by a local authority. Parking may be permitted on payment of a fee at a parking meter. This kind of paid parking can provide a useful source of revenue to the local authority. In all of these types of situation, enforcement of the parking regulations is a major problem.

In the first place, in order to detect infringements, a relatively large staff of permanently moving wardens or inspectors has to be maintained. When they detect an infringement, the issuing of a penalty notice usually comprises issuing a ticket either written by hand or issued by a hand-held machine. Disputes about the issuing of penalty notices are not uncommon, both when the notice is being given and afterwards. Such disputes may depend upon alleged timing of offences and other subjective matters.

The second problem is in the processing of penalty notices which have been issued. These have to be laboriously collected from the wardens at the end of each day and processed by staff at a central location. A certain amount of automation can be obtained if the penalty notices have been entered in a hand-held machine but the process is still slow.

Present parking systems provide problems for people who intend to park as well. In particular, information about parking rules is normally posted on sign posts which are only visible or legible when close to. Much time can be spent seeking a legal parking space.

It is known to provide systems for enforcing traffic regulations, in particular speed regulations and traffic signal regulations. For examples, U.S. Pat. No. 5,948,038 provides a device for detecting the speed of passing vehicles. It can be mounted in an observing vehicle. The operators of the system have to determine while using the system whether or not an infringement has occurred and take the necessary action. A large number of the procedures, including the entry of traffic violation data and transfer of records of traffic violations to a central database are essentially manual.

DE4428306 provides a fixed camera system for observing the speed of passing vehicles. When it detects that an infringement has occurred, the system sends a message to a central processor which automatically issues a penalty notice to the vehicle driver. However, it would not be possible to apply such systems to monitoring and enforcing parking regulations. Whereas the number of points in a road network where speed is to be controlled may be relatively few, the number of points where parking is to be controlled within a city may be very large indeed. It would not be practical to monitor each individual parking space with an individually mounted camera.

The present inventor has set out to provide a system for determining compliance with parking rules which is capable of handling the large number of enquiries necessary to maintain and enforce the parking rules.

The present inventor has further sought to provide a system which can be automated as far as possible.

The present inventor has further set out to provide a system which does not rely upon subjectivity on the part of operators for determining whether an infringement has occurred.

The present inventor has further set out to provide a system which can provide members of the general public with information about parking regulations and which can allow them to purchase permission to park.

The present inventor has realised that a major problem with prior art systems of parking and traffic enforcement is that they rely upon a judgement as to whether an infringement has occurred which is made either by the operator or by a camera at the location where the infringement occurs. Although this is sometimes suitable if there is just one rule to be enforced (for example, traffic speed in a given lane of a highway), it is impractical if there are a large number of units observing traffic or a large number of rules, particularly when rules have to be updated. The present inventor has realised that a significant increase in processing speed and capacity to deal with a large number of infringement enquiries at a given time from a large number of transmitting units can be obtained if all of the rule processing is performed centrally.

Accordingly, the present invention provides an apparatus for determining compliance with parking rules by a vehicle, comprising means for receiving an enquiry signal representing a location selected from a plurality of locations, rule storage means for storing parking rules relating to the plurality of locations, means for obtaining from the rule storage means a rule relating to the selected location, means for determining if a vehicle parked at the selected location complies with the rule and means for transmitting a compliance signal representing the compliance determination.

In practice, a system of determining compliance with parking rules must comprise a plurality of transmitting units, all capable of communicating with an apparatus according to the invention.

Accordingly, the present invention further provides a system for determining compliance with parking rules by vehicles, comprising a plurality of transmitting units for transmitting enquiry signals each representing a location selected from a plurality of location, an apparatus comprising means for receiving enquiry signal from a transmitting unit, rule storage means for storing parking rules relating to the plurality of locations, means for obtaining in response to an enquiry signal from a transmitting unit, a rule relating to the respective selected location from the rule storage means, means for determining if a vehicle parked at the respective selected location complies with the rule, and means for transmitting a compliance signal representing the compliance determination.

By determining compliance of parking rules, it is meant that the apparatus or system is capable of determining if parking is permitted or not. The permission may be absolute (i.e., parking always permitted or never permitted) or it may be conditional (for example only permitted if a fee is paid). The apparatus or system must be capable of:

(a) determining if a vehicle which is actually parked at a selected location is complying with a rule relating to that selected location or if it is infringing the rule, or

(b) determining if a vehicle would comply with a rule if it were parked at a selected location or if it would infringe the rule, or

(c) permitting parking of the vehicle in order to comply with the rule on payment of a fee (i.e. sending a virtual parking ticket).

Preferably, a single apparatus or system is capable of determining any of (a), (b) or (c) above

It may be possible to supply a first type of signal transmitting unit which is for use in detecting infringements as they occur only and a second unit type which is capable of making enquiries about compliance with rules and purchasing parking permission, or a combined unit which is capable of doing all three.

Where the apparatus or system is capable of receiving an enquiry about compliance, means are required for transmitting the information to the enquiring means. This is believed to be inventive in its own right and in a further aspect, the present invention provides an apparatus for providing information about compliance with parking rules by a vehicle, comprising means for receiving an enquiry signal from an enquiry unit, the signal representing a location selected from a plurality of locations, rule storage means for storing parking rules relating to the plurality of locations, means for obtaining from the rule storage means a rule relating to the selected location and means for transmitting a signal representing information about the parking rule to the enquiry unit.

Suitably, the apparatus is configured to respond differently to an enquiry of the type (a), to an enquiry of the type (b) and to an enquiry of type (c).

The inventor has realised that a member of the general public using the system might be concerned that making an enquiry would automatically yield a parking fine if they had inadvertently parked at a forbidden location whilst making an enquiry about that location or trying to purchase parking permission at that location. In order prevent this happening and to maintain confidence in the system, the present inventor has realised that it may be possible to substantially separate enquires about parking rules, determination of compliance and purchase of parking permission from each other. To achieve this, the identification of the signal-transmitting unit may further comprise an identification of the signal type, the apparatus comprising separate compliance determining means for different signal types and means for directing a signal to the compliance determining means appropriate to the type of signal. For example, there may be a substantially separate processor for determining if compliance is occurring and a penalty is due, a substantially separate processor for determining if parking would comply with parking rules and a substantially separate processor for allowing parking permission to be purchased. Each processor may comprise separate rule storage means and compliance determining means.

As an alternative, different types of enquiry may be physically separated from one another, for example by providing a separate signal receiving means for each enquiry type, which is configured to transmit the enquiry only to a processor of the appropriate. This may be achieved, for example by allotting a specific frequency for wireless communication to each type of signal transmitting unit and signal receiving means. It may be possible to substantially combine parking purchase and parking enquiry within a single processor, as there is less need to separate these two functions.

In a preferred embodiment, there are a plurality of compliance determining means, selected ones of the separate compliance determining means being prevented from forwarding signals received from transmitting units appropriate to the selected compliance determining units to selected other compliance determining means. However, signals resulting from processing of signals received from transmitting units using the rules or logic of a first compliance determining means may be transmitted to other compliance-determining units. For example, if a parking purchase enquiry is received, it cannot be passed to the parking compliance determining means directly. However, once it has been processed and parking has been purchased, a record of the parking purchased may be passed to the parking compliance determining means. In this way, accidental or unauthorised communication from one type of enquiry into the database, system or connections of another type of system will be prevented. For example, when the compliance determining means is configured to determine if an infringement is actually occurring, it may be prevented from accessing data relating to enquiries by members of the public who have enquired whether they are permitted to park in a given zone.

The different types of signal transmitting unit will be discussed later below.

Preferably, the signal receiving means is a wireless signal receiving means. This is almost essential if the signal transmitting unit is not mounted in a fixed position. By establishing a wireless connection between the signal transmitting unit and the apparatus, the signal transmitting unit can be allowed to move around over a wide range. The wireless connection may be any suitable wireless connection means, for example a direct radio, cellular telephone, microwave or other connection means.

The plurality of locations may be represented by designations, for example red route, yellow line, double yellow line etc, or a code denoting each location uniquely. However, it is particularly preferred that the plurality of locations are defined by coordinates on a grid map. As will be explained further below, these coordinates are preferably determined with reference to a distant reference point. For example they may be determined by GPS, (geopositionary satellite) techniques or they may be augmented or supplemented by “pseudolites” (ground based pseudo satellites transmitting GPS-like signals) or INS (inertia navigation system, which measures angular velocity and acceleration to calculate position with reference to a known starting position by dead reckoning), where the satellite signals are insufficient, obscured or unreliable. For the purposes of the present application, references to ‘distant-reference determined coordinates’, ‘distant-reference determination’ and equipment for this process will refer to any selection or combination of satellite determination, inertial navigation and pseudo-satellite determination, including GPS, GLONASS, GNSS, INS, Pseudolites and any similar technology capable of resolving location sufficiently accurately. In particular, the term shall cover any method of determining location which is not dependent upon an observation of means local to a place for determining the position of that place, either by the user or by the apparatus. Thus, the present system need not require every possible place covered to be labelled (physically or electronically).

In the rule storage means, parking rules relating to each of the plurality of locations are provided. Where the locations are defined by coordinates, a group of coordinates are suitably linked to the same rule. Preferably, the rule storage means comprises a first rule storage means, providing a many—to—one map between coordinates and rule designators and a second rule storage means in which each rule designator is associated with its associated rule logic.

Suitably, the rule logic in each case is written as the conditions which would lead to an infringement being deemed to have occurred. For example, in some zones, there will be infringement if a vehicle is parked or stopped at any time. Alternatively, in some areas, parking is permitting between certain time periods and forbidden at other times. In such areas, the rule logic would state that there is infringement if a vehicle is parked in the zone and the time is between for example, 0700 hrs and 1800 hrs. The second rule storage means may further specify a penalty which is to be activated if infringement has occurred. The rule storage means may further specify a third party to whom a signal should be sent if infringement has occurred.

The rule logic may provide that there is no infringement if the vehicle or vehicle driver is specially permitted to park for some reason. For example, local Doctors, Ambulances, the Police, Fire Services or other emergency services may have permission to park anywhere at all times. In some areas, residents may be permitted to park without purchase of a ticket.

Once the apparatus or system has determined whether the rule is complied with or infringed, a compliance signal indicating that the rule is “complied with” or “not complied with” is given. The means for transmitting the compliance signal representing the compliance determination may be transmitted by any suitable means, for example, the Internet, an intranet, dedicated telephone lines etc.

In a first embodiment, the compliance signal is transmitted to the signal transmitting unit to advise the signal transmitting unit whether or not an infringement has occurred or will occur. This is particularly useful if an enquiry has been made by a member of public as to whether they are allowed to park in a given zone. In order to allow this to occur, the signal transmitting unit is suitably configured to include in the request signal an identification of the individual signal transmitting unit making the enquiry. The signal receiving means is then configured to receive the signal comprising the identification of the signal transmitting unit. Means are suitably then provided for processing or recording the identification of the signal transmitting unit and for transmitting the compliance signal to the appropriate signal transmitting unit.

Many rules on parking may be complied with on condition that a fee is paid by the driver of the vehicle. That is, the driver needs to purchase a real or virtual parking ticket Accordingly, the compliance signal may further comprise an identification of a parking fee to be paid if the rule is to be complied with. The signal transmitting unit may be configured to transmit a parking purchase signal in order to purchase parking for the selected location. The compliance determining means is then preferably configured to process the payment of the parking purchase fee and to transmit a further compliance signal if parking is successfully purchased. Parking purchase storage means may be provided in which a record of parking purchase by a given signal transmitting unit may be stored. The record stored in the parking purchase storage means preferably comprises an identification of the signal transmitting unit, an identification of the location in which parking has been purchased, and any conditions attached to the purchase parking, for example a time limit.

In a second embodiment, if there is no compliance, the compliance signal is passed to an infringement penalty administering system. The infringement penalty administering system may be combined with the apparatus for determining compliance. Alternatively, it may be located separately.

The infringement penalty and administering means may be substantially the same as conventional systems in which penalties are processed manually. However, it is an advantage of the present invention that the penalty administration can be carried out substantially automatically. An embodiment of the system of the invention in which an infringement notice is automatically sent to the owner of or vehicle or driver of the vehicle will be described later below.

It is particularly preferred that the apparatus comprises compliance storage means for recording records of compliance determinations. This compliance storage means can be used as a source of evidence in enforcing penalties against alleged infringements if necessary.

For example, if a penalty notice is issued, the recipient may allege that no infringement in fact occurred. It may be necessary to resort to litigation to recover the fine. In order for such litigation to be successful, it will be necessary to have evidence that the infringement occurred.

In a preferred embodiment of the invention, means are provided for preventing access to the compliance storage means by unauthorised persons. This may be provided in order to ensure that the compliance storage means is considered to be tamperproof and a reliable store of evidence. Further, it may be provided in order to prevent third parties obtaining information about the whereabouts of vehicles, when they are not entitled to receive that information. In order to further secure the compliance storage means, the identification of the signal transmitting unit may comprise a secure identification. The secure identification may comprise a unique code which could only be part of the signal from the signal transmitting unit if the signal transmitting were being operated by an authorised user.

The authorised user may input the secure identification by any suitable means, for example by typing in a code number which has been previously assigned to the authorised user. Alternatively, the authorised user may be supplied with a smart card or other device encoding the secure identification, the signal transmitting unit being configured to read the code in the key.

The apparatus can comprise dedicated hardware or programmable hardware or even a combination. The programmable hardware can comprise any suitable programmable device such as general-purpose computer. In order to configure the programmable device to operate in accordance with the invention, suitable programme code can be provided to the device using any conventional carrier medium, e.g. floppy disk, CD-ROM, tape device, or programmable logic device or a transient carrier medium e.g. electrical, an optical, microwave or radio frequency signal. An example of the application of a transient signal is the downloading of programme code over a network e.g. the internet.

As mentioned above, it is preferred that the selected location is represented by coordinates, in particular distant-reference determined coordinates, such as satellite determined coordinates (such as GPS coordinates or the new European GNSS coordinates), pseudo satellites or INS, as described above.

The manner of determining the coordinates is well known in the art and apparatus can be obtained which is suitable for carrying out this operation. In outline, GPS satellite are continuously emitting signals which indicate the time at which they were transmitted. By comparing the times received from a number of satellites (preferably four or more) a location can be obtained. The accuracy of the GPS system used in this way is known to be in the range of approximately plus or minus 100 m but is capable of being made more accurate, using procedures well known in the art such as Real Time Kinematic Differential GPS, which involves calculations with respect to the phase of signal carriers and reference to near-simultaneous readings from a known fixed point, giving an accuracy of plus or minus 10 cm or better. Such accuracy is suitable for determining the location of an observer or a vehicle on a road with sufficient accuracy to determine if that vehicle is infringing parking rules, which commonly relate to zones which are of the order of least several metres in size. Where signals from the satellites are not receivable to a sufficient standard for accurate positioning, the use of Pseudolites (pseudo-satellites—ground based devices transmitting GPS-like signals) can be used and for limited durations, INS (Inertia Navigation Systems) measuring angle of velocity and acceleration may maintain relative positional information for brief interruptions of signal, independently of external input.

The result representing the selected location may simply indicate the position of the transmitting unit, determined as above by a distant-reference coordinate determining system

This is particularly suitable in the case where the signal transmitting unit belongs to a member of the public and is located in their vehicle, allowing an enquiry to be made as to whether the vehicle may park in the position where it is located or allowing parking to be purchased.

It could also be used by traffic wardens, requiring the traffic wardens to stand by a vehicle, or as close to it as possible, to determine if that vehicle complies with or infringes parking regulations.

However, the present inventor has realised that a very powerful system can be provided if the signal transmitting unit comprises a vehicle observing unit which is capable of determining its own position by a distant reference positioning method and further determining the position of a vehicle with respect to the vehicle observing unit, the selected location being provided by the distant-reference determined coordinates of the vehicle observing unit combined with coordinates representing the position of the vehicle with respect to the vehicle observing unit.

In particular, it is preferable that the vehicle observing unit comprises sighting means for pointing at the vehicle, a range finding means for determining the distance between the observer unit and the vehicle when the observing unit is sighted on the vehicle, means for determining the inclination to horizontal of the line of sight joining the vehicle and the observing unit and means for determining the compass bearing of the line of sight joining the vehicle and the observing unit. Once these data are known, by simple trigonometry the position of the vehicle in distant-reference determined coordinates may simply be calculated by applying a correction to the distant-reference determined position of the vehicle observing unit. It should be noted that, when determining position, the vehicle location calculated represents the closest end of the vehicle to the observation unit. The compass bearing of the vehicle form the observing unit may be used to further enhance the accuracy of the position calculation. For example, the range vector of the vehicle from the observing unit may be extrapolated linearly by a suitable correction distance, for example 1 m, to find the midpoint of the vehicle.

It is particularly preferred that the sighting means comprises means for obtaining an image of the vehicle, as will be described later below.

The signal transmitted by the signal transmitting unit and received by the signal receiving means suitably comprises an identification of the vehicle. Where the signal transmitting unit is a vehicle observing unit used to detect infringements, this will allow penalties for parking infringements to be directed to the owner or user of the vehicle. Where the signal transmitting unit is a parking purchase or enquiry unit, the apparatus will be able to identify when a parking ticket has been purchased by the vehicle driver. Parking purchase will be described later below.

Where the signal transmitting unit is used by a member of the public to purchase parking, the member of the public may simply input the vehicle registration by any suitable means. For example, it may be typed in or it may be stored in a memory of the signal transmitting unit. Alternatively, the vehicle registration may be input using a smart card or other code caring means which can engage with the signal transmitting unit. Preferably, the identification of the signal transmitting unit includes not only the vehicle registration number but also an identification of the vehicle driver at the time. In this way, if several users use the same vehicle at different times, parking purchase can be attributed to the account of the driver who is actually making the purchase.

A signal transmitting unit for use by a member of the public to purchase parking may be further configured to check at regular intervals after parking has been purchased to see if the vehicle has moved. For example, the unit may be configured to determine the position of the vehicle in distant reference determined coordinates and to compare them with the position in distant-reference determined coordinates at the time the parking was purchased. If it is determined that the vehicle has moved, a signal may be transmitted to the central apparatus to indicate that the vehicle has moved.

According to the invention, the signal transmitting unit for use by a member of the public has no rule storage means in the unit itself. This ensures that rule determination must be made by a central apparatus. This central apparatus is much easier to update with regard to changes in parking rules. If the signal transmitting unit for use by a member of the public had a rule storage means, there could be a conflict between a rule stored in the signal transmitting unit and the central unit, which would damage the operability of the system.

When the signal transmitting unit is a vehicle observation device for detecting infringements, the registration number may also be input by typing it in. However, in a particularly preferred embodiment, the vehicle observing unit comprises camera means for capturing an image of the vehicle registration plate of the vehicle. The vehicle observing means may perform an image analysis to identify the vehicle registration from the digital image. However, is particularly preferred that processing is carried out centrally by the apparatus with which the vehicle observing means communicates. Accordingly, it is particularly preferred that the signal transmitting means is for transmitting a signal comprising a signal representative of a digital image of the vehicle registration plate. Any suitable image analyses means may be employed by the apparatus.

In order to provide a vehicle observing means which can be carried from place to place and which is capable of determining the position of a parked vehicle and obtaining an image of the registration plate to allow it to be identified, the present invention further provides a mobile vehicle observing means for providing data for determining the position of a parked vehicle, comprising camera means for obtaining a digital image of at least the registration plate of a vehicle, position detecting means, for detecting the position of the mobile device, range determining means for determining the range of the vehicle from the mobile device, direction determining means for determining the direction of the vehicle with respect to the mobile device, and transmitting means for transmitting signal representing the image of the vehicle, the direction and distance of the vehicle from the mobile device to an apparatus. Preferably, the mobile vehicle observing means comprises means for transmitting an identification of the mobile vehicle observing means to the apparatus. The transmitting means is suitably a wireless transmitting means as described above.

It is particularly preferred that the mobile vehicle observing means comprises user identification means for identifying a user of the mobile vehicle observing means, to provide a form of authorisation of images and data obtained by the mobile observing means. Suitable means have been described above.

The present invention may further include a penalty administration system. The penalty administration system is configured to receive a signal representing the compliance determination from the compliance determining apparatus, the signal further including an identification of the vehicle. The determination of the non compliance (i.e. infringement) suitably includes an identification of the rule infringed. The signal may include an identification of the penalty. Alternatively, the penalty administration means may comprise penalty storage means for storing information relating to penalties incurred when specified rules are in infringed.

Commonly, the penalty will comprise a fine. In order to enforce the fine or other penalty, it will normally be necessary for the penalty administering means to send a notice to the contact address of the vehicle owner identifying the date and time and the rule infringed. The notice may further comprise penalty information, for example information relating to a fine to be paid. This may include an identification of the sum to be paid, the date by which it must be paid and any reduction of the fine which may be obtained by prompt payment of the fine. The penalty information may be stored in the penalty storage means described above.

In order to identify the contact address and name of the vehicle owner, an owner identification request may be made to means for storing vehicle owners and vehicle registration numbers. This storage means may be held by the apparatus itself. In the alternative, it may be held by vehicle registration authority, such as the DVLA in Swansea, United Kingdom. In response to this request, a signal comprising the vehicle registration and owner contact details may be obtained.

The penalty administration system can comprise dedicated hardware or programmable hardware or even a combination. The programmable hardware can comprise any suitable programmable device such as general-purpose computer

The present invention allows members of the public to make enquiries about parking regulations. In order to do this, the present invention further provides a device for obtaining parking information for a vehicle, the device being mountable in a vehicle and comprising means for determining the position of the vehicle, transmitting means for transmitting a request to an apparatus, the request comprising an identification of the vehicle position and a request identification, receiving means for receiving a parking rule from the apparatus and means for displaying the parking rule.

It is required that the request transmitted identifies the device making the request, so that the rule can be transmitted to the correct device.

In a preferred embodiment, the system will also allow members of the public to purchase parking tickets remotely. Accordingly, the apparatus preferably comprises means for receiving a signal representing a location selected from the plurality of locations and an identification of a transmitting unit, rule storage means for storing parking rules relating to the plurality of locations, means for obtaining from the rule storage means a rule relating to parking at the selected location, means for determining if parking is permitted and a parking fee, means for transmitting to the transmitting unit an indication as to whether parking is permitted and a request for payment of a parking fee, means for receiving a parking fee payment instruction from the transmitting unit, parking purchase storage means for recording the fee paid, the transmitting unit identification, selected location and the time.

The transmitting unit suitably comprises a device for obtaining parking information as described above, further comprising means for receiving from the apparatus an indication as to whether parking is permitted and a request for payment of the parking fee, means for transmitting a payment instruction to the apparatus and means for receiving from the apparatus confirmation that the fee has been paid.

The payment instruction may comprise any suitable instruction. For example, the apparatus may comprise account storage means, comprising a plurality of records of purchasers and an account balance for each purchaser, the apparatus further comprising means for debiting or crediting the account storage means. In this case, the transmitting unit may transmit an instruction to the apparatus to debit the purchaser's account by a sum equal to the parking fee. In order to prevent an unauthorised person from debiting a purchaser's account, secure account identification means may be provided, for example a unique code. The code may be input by the purchaser at any suitable stage, for example, when the parking request is transmitted to the apparatus.

Alternatively, credit card payment means may be employed, in a manner which is known in the art for purchases via communications networks such as the Internet.

The present invention will be described further below with reference to the accompanying drawings, in which:

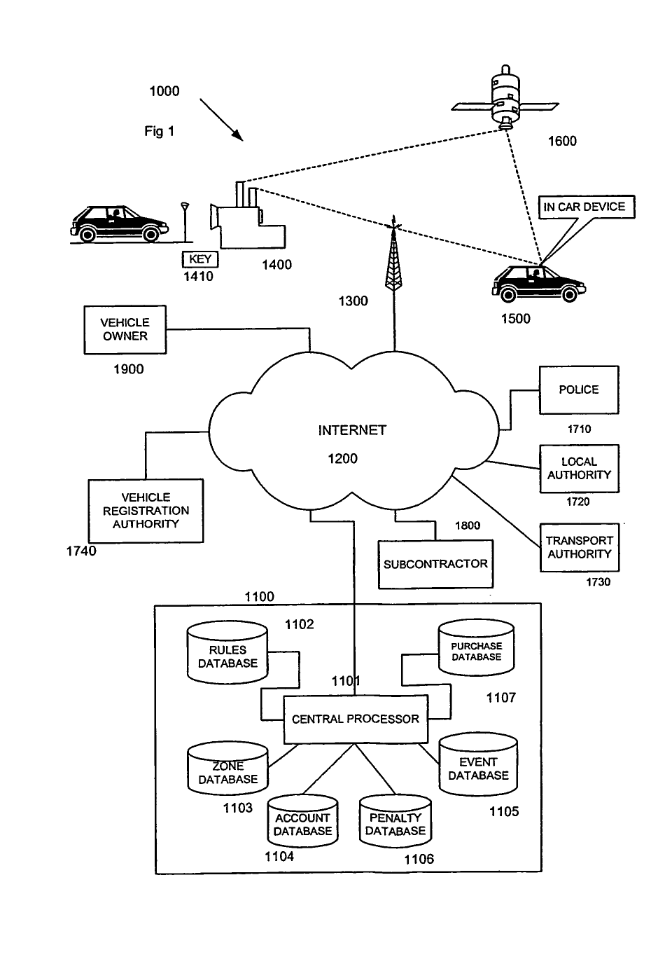

FIG. 1 is a schematic view of a system for determining compliance with parking rules by a vehicle, according to the invention.

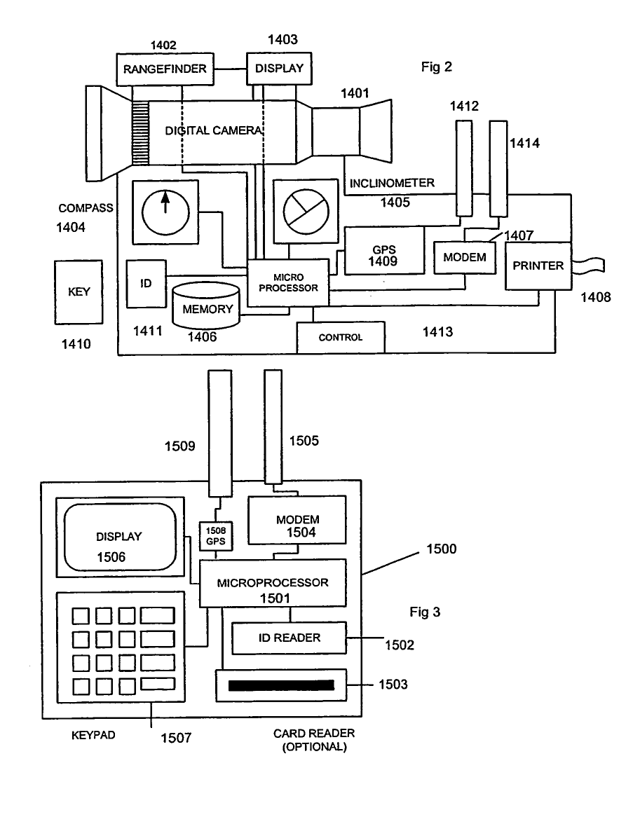

FIG. 2 is a schematic illustration of a mobile vehicle observing device according to the invention.

FIG. 3 is a schematic view of a device for obtaining parking information according to the invention.

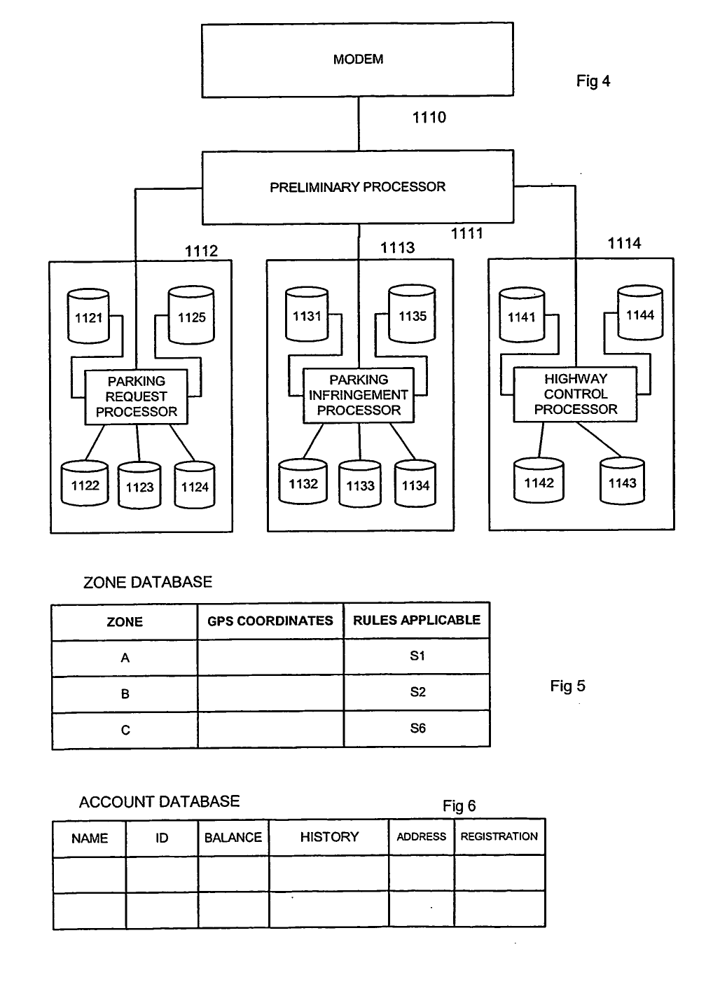

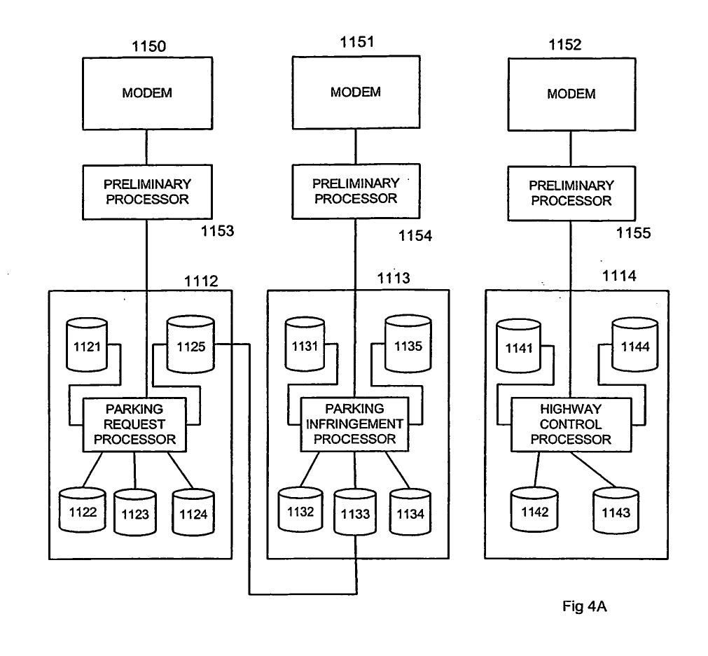

FIG. 4 is a schematic view of an apparatus for determining compliance with parking rules, according to a second embodiment of the invention.

FIG. 4a is a schematic view of an apparatus for determining compliance with parking rules, according to a third embodiment of the invention

FIG. 5 is a schematic illustration of a zone database for use in the apparatus of the invention.

FIG. 6 is a schematic illustration of an account database for use in an apparatus according to the invention.

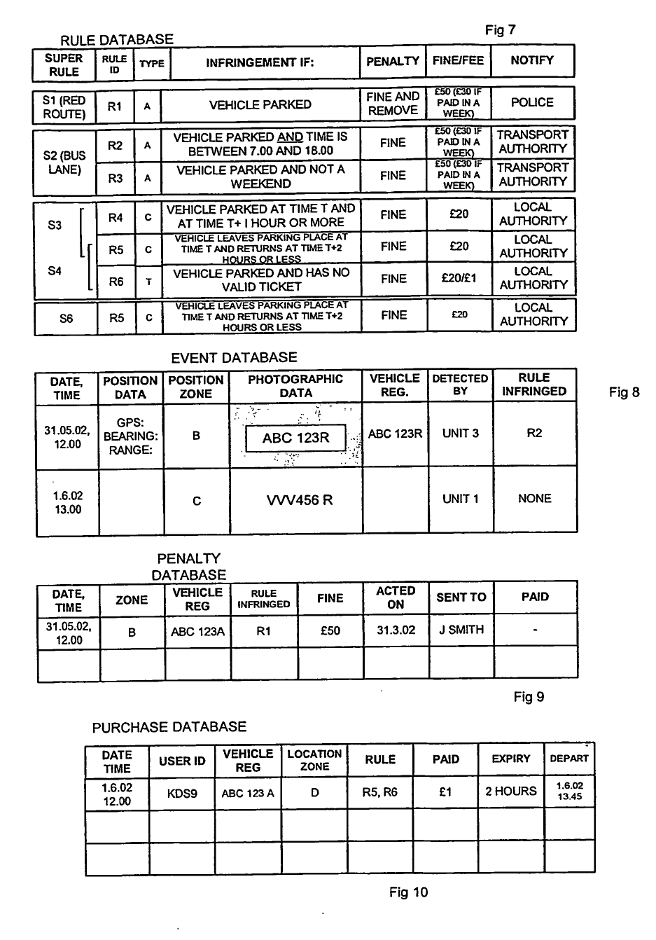

FIG. 7 is a schematic illustration of a rule database for use in an apparatus according to the invention.

FIG. 8 is a schematic view of an event database for use in an apparatus according to the invention.

FIG. 9 is a schematic view of a penalty database for use in an apparatus according to the invention.

FIG. 10 is a schematic view of a purchase database for use in an apparatus according to the invention.

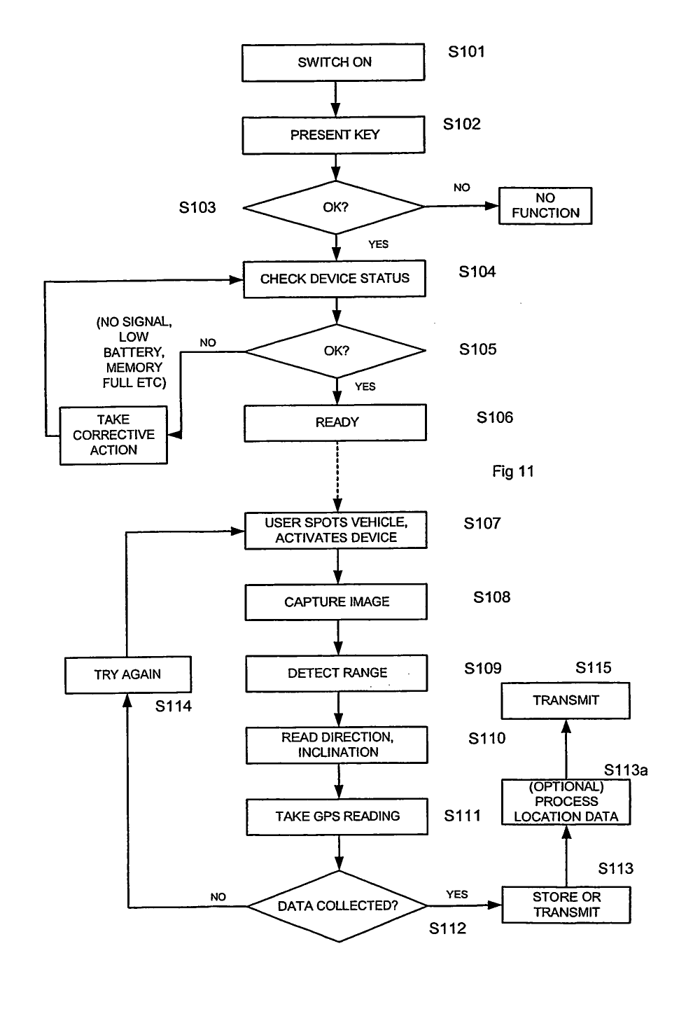

FIG. 11 is a schematic view of the steps involved in obtaining data for determining the position of a parked vehicle.

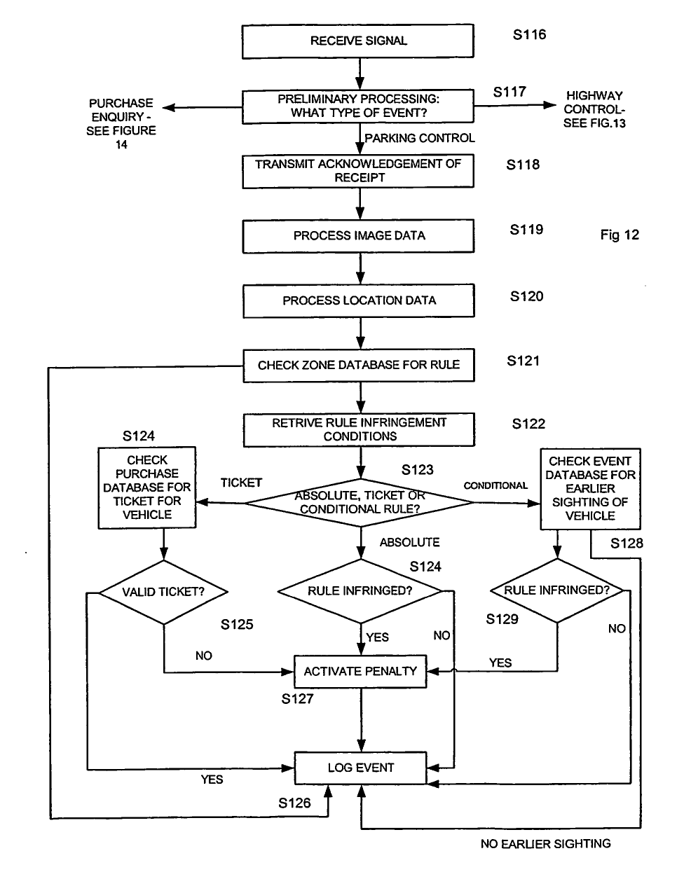

FIG. 12 shows the steps involved in determining if a vehicle complies with parking rules by a vehicle.

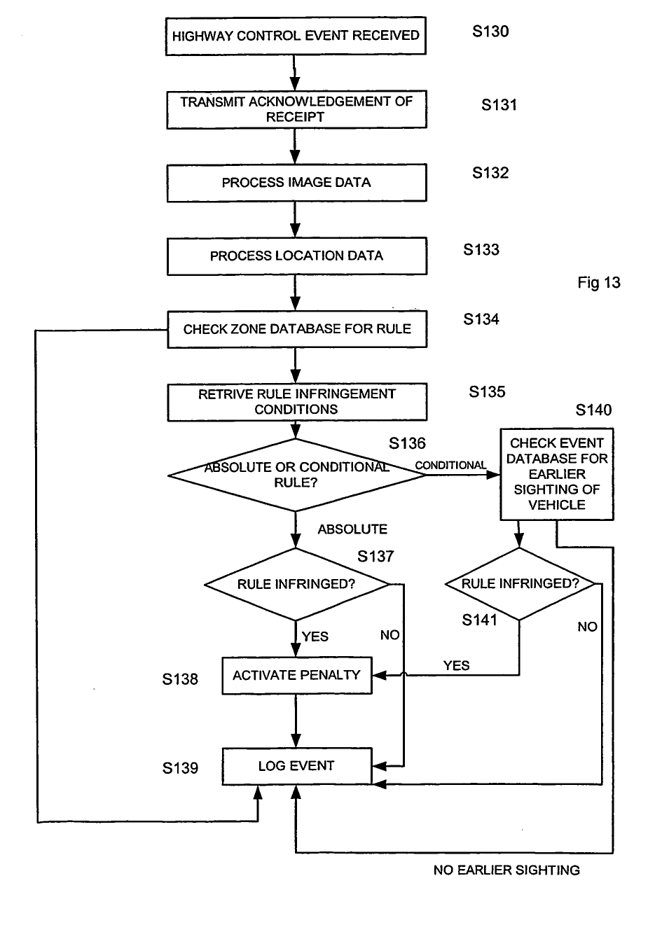

FIG. 13 shows the steps involved in determining if a vehicle complies with highway parking rules.

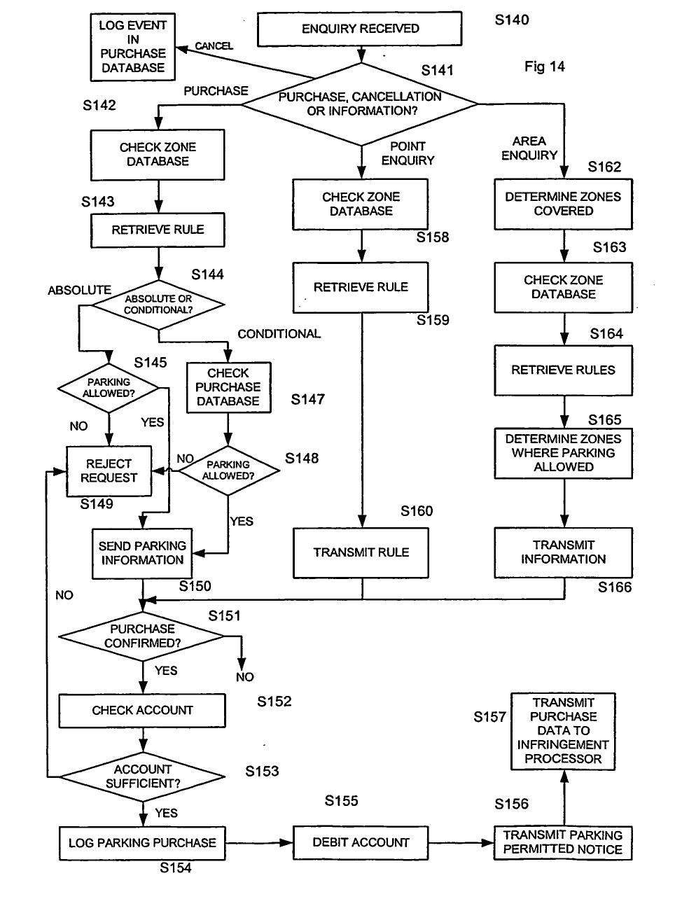

FIG. 14 shows the steps involved in making a parking rule enquiry, including the steps involved in purchasing a parking ticket.

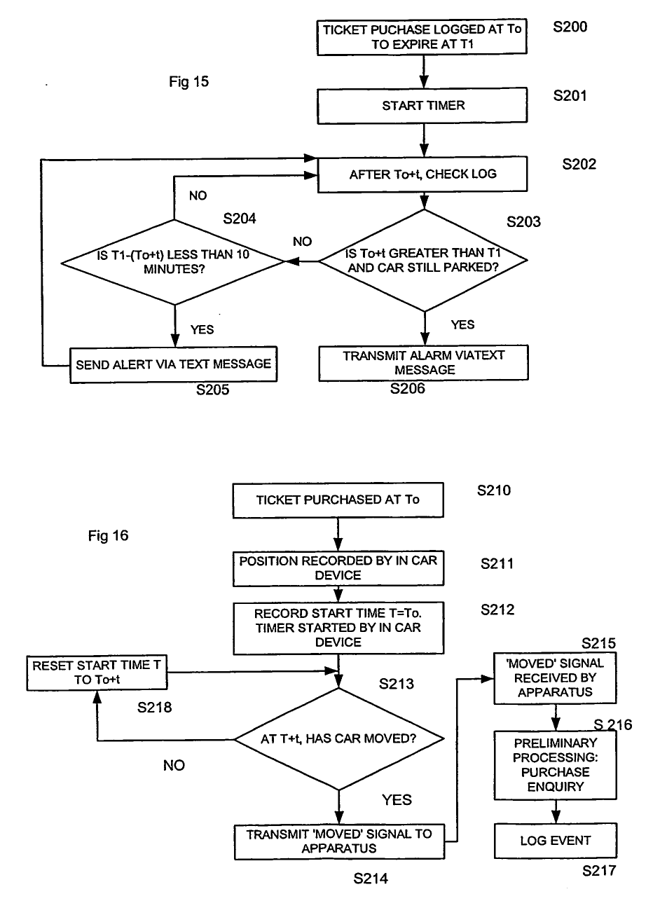

FIG. 15 shows the steps undertaken in a ticket purchase device, after a ticket is purchased.

FIG. 16 shows the steps involved in notifying the apparatus that a vehicle is moved.

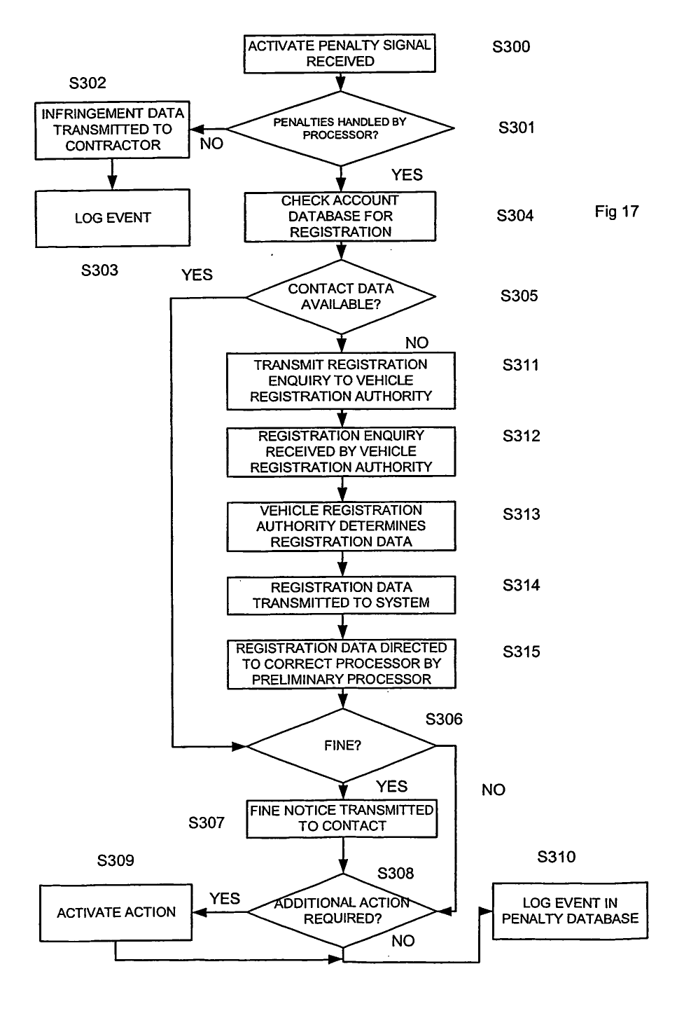

FIG. 17 shows the steps involved in activating a penalty.

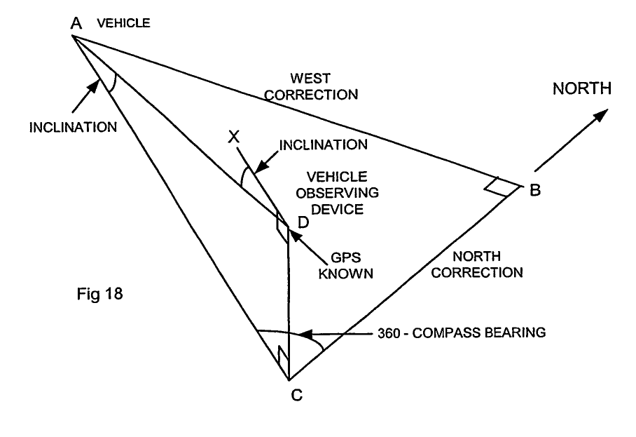

FIG. 18 is a schematic diagram showing how the position of the vehicle may be calculated in an apparatus according to the invention.

FIG. 1 shows a system generally designating 1000 for determining compliance with parking rules by a vehicle. The system comprises a central apparatus 1100 which will be described further below.

The central apparatus 1100 is connected via communication system, in this case the internet 1200 to a radio transmitter/receiver 1300. The radio transmitter/receiver 1300 is in radio communication with a mobile vehicle observing means 1400 and a device for obtaining parking information for a vehicle 1500. The mobile vehicle observing means 1400 and the device for obtaining parking information each comprise satellite position detecting means such as GPS, as will be described further below. They are accordingly configured to receive signals from satellites, one of which 1600 is shown.

The vehicle observing device 1400 is activated by a key 1410 as will be described further below.

The central processor 1100 may be further connected via the communications network 1200 to authorities such as the police 1710 a local authority 1720 and a transport authority 1730. It may also be connected to a sub contractor 1800 who is contracted to perform various task for the owner of the central apparatus.

Also connected to the communications network 1200 are vehicle owners at 1900 and a vehicle registration authority 1740.

The central processor could also be directly connected to the radio transmitter/receiver 1300.

The central apparatus 1100 comprises a central processor 1101. The central processor is connected to a rules database 1102, zone database 1103, an account database 1104, an archive 1105, a penalty database 1106 and a purchase database 1107, which, will be described further below.

FIG. 2 is a schematic view of a mobile vehicle observing device for providing data for determining the position of parked vehicles. The mobile vehicle observing device 1400 comprises an image obtaining means in a form of a digital camera 1401, a range finder 1402, a display 1403, a compass 1404, an inclinometer 1405, a short term memory 1406, a modem 1407, a printer 1408, a GPS positioning detecting means 1409, an identifying key 1410, a key recognising means 1411 a GPS aerial 1412 and a radio communications aerial 1414.

The digital camera 1401 can be used to obtain digital images of vehicle registration plates. The range finder 1402 calculates the range from the observing device to a parked vehicle. The compass 1404 can be used to determine the bearing of the parked vehicle from the observing means when the user obtains an image of the vehicle using the camera 1401. The inclinometer 1405 can be used to obtain the inclination to the horizontal of the line of sight joining the vehicle and the observing means.

Signals from the plurality of geopositionary satellites can be received by the aerial 1412 and fed to the GPS device 1409. The GPS device 1409 is configured to calculate the position of the observing device from the signals received from the GPS satellites, in a manner known in the art.

The digital camera 1401, range finder 1402, compass 1404, inclinometer 1405 and GPS means 1409 are connected to a microprocessor which controls them. The microprocessor assembles data from these devices and stores the data in a short term memory 1406. Display 1403 is provided so that the user can determine if all of the details have been correctly obtained.

In one embodiment, the microprocessor is configured to combine the GPS position of the observing device obtained by GPS device 1409 with the range data from the range finder 1402, bearing data from the compass 1404 and inclination data from the inclinometer 1405, to calculate the position of the vehicle in satellite determined coordinates.

The use of the key and key recognising means 1411 to allow the device to be used by an authorised user will be described further below.

When the user determines from the display that all of the data has been correctly obtained, the control 1413 can be used to instruct the microprocessor to transmit a signal via a modem 1407 and aerial 1414 to a central apparatus, comprising the identification of the observing means, a digital image of the vehicle number plate and the vehicle location data. The vehicle location data may comprise the position of the vehicle determined as set out above or a set of data comprising the range of the vehicle from the observing-means, the compass bearing of the line of sight joining the vehicle and the observing means, the inclination of the line of sight joining the vehicle and the observing means to the horizontal, the GPS determined position of the observing means to the central apparatus. The printer 1408 may be used to print a short record of the data sent for accounting purposes. Preferably, the microprocessor deletes the data from the short term memory 1406 a short period after it has been transmitted. In this way, the vehicle observing device does not contain a record of infringements and thus may not become a target for vandalism or theft.

FIG. 3 is schematic view of a device for obtaining parking information according to the invention.

The device comprises a microprocessor 1501. The microprocessor is connected to a keypad 1507 which allows the user to input request information.

It is further connected to an identification device reader 1502, which can be used to identify a user, for example, by a reading a card presented by the user. It may also be connected to a credit card reader 1503 or smart card reader, for performing transactions. The microprocessor 1501 is also connected to a modem 1504, a satellite coordinate determining device 1508 which processes signals received from satellites via a GPS aerial 1505.

The microprocessor is configured to determine using the GPS satellite coordinate determining means 1506 the position of the device 1500 and to instruct the modem 1504 to send a signal via a radio communications aerial 1509 to a central parking enquiry apparatus as shown in FIG. 1. The signal comprises the position of the vehicle in satellite-determined coordinates and an identification of the vehicle and/or vehicle driver which may be input by the keypad or by the ID reader 1502. The microprocessor is further configured to receive from the aerial 1509 and modem 1504 a wireless signal from the central parking enquiry apparatus of FIG. 1 indicating whether parking is permitted and the fee for parking. The microprocessor is configured to display the parking information on the display 1506. The microprocessor is configured to receive instructions from keypad 1507 and in response to send a signal via the modem to the central parking apparatus of FIG. 1 to purchase parking as will be discussed further below.

The microprocessor may be configured to check the position of the vehicle in satellite-determined coordinates at regular intervals after parking has been purchased, in order to determine if the vehicle has moved. The microprocessor may be further configured to send a signal to the central apparatus to indicate that the vehicle has moved (as described in relation to FIG. 16 below).

FIG. 4 shows a second embodiment of apparatus for determining compliance with parking rules. It comprises a modem 1110 for receiving and transmitting signals to and from a communications network, for example the internet as shown in FIG. 1.

The apparatus further comprises a preliminary processor 1111. The preliminary processor is configured to analyse incoming signals from the modem and to determine from an enquiry type indicator in the signals whether they relate to a parking request enquiry, a parking compliance enquiry or highway control compliance enquiry. The preliminary processor may also check the incoming signals to check that they have been sent by an authorised user. The preliminary processor 1111 is configured to direct parking enquiries to the parking request processor 1112, parking compliance enquiries to the parking compliance processor 1113 and highway control enquiries, to the highway control compliance processor 1114.

The parking request processor 1112 comprises a rule database 1121, a zone database 1122, an account database 1123, an event database 1124 and a purchase database 1125. The parking compliance processor comprises a rule database 1131, a zone database 1132, a parking purchase database 1133, an event database 1134 and a penalty database 1135.

The highway control processor 1114 comprises a rule database 1141, a zone database 1142, an event database 1143 and a penalty database 1144.

The preliminary processor 1111 is configured to prevent enquiries being directed to the wrong type of processor. Accordingly, a parking request cannot trigger a parking compliance or infringement reaction in the parking compliance processor 1113 or Highway control processor 1114. In this way, public confidence in the system and protection of data can be secured. However, the parking request processor 1112 may be configured when parking has been purchased to send a signal via the preliminary processor 1111 to the parking compliance processor 1113 to write parking purchase information in the parking purchase database 1133.

FIG. 4a shows a third embodiment of the invention. It is similar to the embodiment of FIG. 4 and similar components are similarly numbered. However, there is a separate receiving means for receiving parking enquiry signals, parking purchase signals and highway control enquiry signals. Each separate receiving means comprises a radio or microwave receiver (not shown) tuned to a frequency which is specific to the enquiry type. Each receiver is connected to a modem 1151, 1152 or 1153. Each modem is connected in turn to a specific preliminary processor 1154, 1156 or 1157, which is configured to check that the incoming signals have been sent by an authorised user. Each preliminary processor is connected in turn to one of the parking request processor, parking infringement processor or highway control processor. In this way, the different types of enquiry are kept separate. In order to allow records of parking purchase to be written into the parking purchase database 1133 of the parking infringement processor, a direct link is provided from the parking purchase database 1125 of the parking purchase database.

FIG. 5 is a schematic view of a zone database which may be used in any of the processors 1100, 1112,1113, or 1114.

The zone database links a zone code or name, represented by the letters A, B, C with a range of coordinates which correspond to that zone and rules which apply in that zone. In this case, the rules are identified by a code which will be explained below in relation to FIG. 7. The zone names may in practice comprise street names, for example ‘Maxwelton Avenue, left side’.

FIG. 6 is a schematic view of an account database which may be used in the apparatus of FIG. 1 or 4. The account database links the names of vehicle drivers or vehicle owners with an identification code to which may be input by the owner or driver, an account balance an account, history, detailing credits and debits to the account, a contact address for the vehicle owner or driver and a registration number of a vehicle.

FIG. 7 is a schematic view of a rule database.

The rule database is configured so that super rules S and normal rules R are defined. A super rule is a general rule which applies to a given area. Within that area, there may be ordinary rules for portions of the area covered by the super rule. Each rule is classified according to rule type, depending upon whether it is an absolute rule A, in which case infringement can be simply determined, or a conditional rule C, in which infringement only occurs if specified actions have occurred in the past It may also be a ticket rule (T) concerning ticket purchase. The rule database associates with each rule the rule logic which indicates when the rule is infringed. The rule database also identifies the penalty if the rule is infringed, the fine if a fine is to be paid and an identification of one or more third parties to be notified if the rule is infringed.

The rule database in FIG. 7 is sub-divided into three sections. Although the rule databases 1121, 1131 and 1141 of FIG. 4 could each contain all of the rules, it is also possible that the respective rule databases could contain different versions of the rules which reflect their different purposes.

In the first line of the rule database shown in FIG. 7, a super rule S1 is shown. This is super rule which relates to red routes, where parking and stopping are forbidden at all times. There is a single rule R1 under super rule S1. It is an absolute rule and it is infringed if a vehicle is parked in the zone. The response is to issue a fine and to notify the police to remove the offending vehicle, to prevent blockage of the red route. The fine given is £50 but may be reduced to £30 if paid with a period of a week.

The second section of the rule database relates to super rule S2 which is the rule which applies to bus lanes. There are two different rules, R2 and R3. Both are absolute in the sense that infringement can be determined immediately if a vehicle is detected in a zone covered by S2. For example, under R2, there is an infringement is a vehicle is parked in a zone covered by R2 and the time is between 0700 and 1800 hrs. The rule database server indicates the penalty, in this case a fine, the sum of the penalty and the person to notify. In this case, the person to notify is the transport authority who may need to take action to remove the vehicle from the bus lane, to prevent blockage.

The third section of the rule database comprises a pair of super rules S3 and S4. S3 comprises two rules R4 and R5. S3 is a super rule which is applicable to unpaid time-limited parking. According to this example of unpaid time limited parking, vehicles are permitted to park for no more than an hour and are not allowed to return to the parking place within two hours. Similarly, S4 is a super rule which applies to paid parking. In this case, a vehicle must have a valid ticket (R6) but is not allowed to return to the parking place within two hours (R5). The rule database further identifies the fines and penalties if these rules are infringed and indicates that if there is an infringement, a notification may be sent to the local authority, for example to collect fines.

Super Rule S6 consists of the single Rule R5 as described above.

The rule logic described in FIG. 7 may be further modified for some or all rules by following two items of rule logic:

a) specialist vehicles and drivers

certain specialist vehicles or drivers, such as emergency vehicles, Doctors, Police etc. may be permitted to park in any zone in order to allow the emergency services complete freedom to operate. Accordingly, the rule logic will further include a statement that there is infringement if the main rule is infringed and if the vehicle is not registered as a permitted vehicle. The data recording permitted vehicles may be recorded for example in the purchase database in the parking request processor 1112 or the parking compliance processor. Data relating to permitted vehicles may be stored in a further database in the Highway control processor 1114.

b) Residents parking.

In the parking purchase processor and parking compliance processor, the rule logic may further comprise a rule allowing that there is no infringement if the vehicle parked belongs to a resident or other local permitted user. The data relating to local permitted users may be stored in the parking purchase database.

FIG. 8 is a schematic view of an event database for use in an apparatus according to the invention. The role of the event database is to record, in a secure fashion, compliance enquiry signals transmitted by a vehicle observing means for example as shown in FIG. 2. The event database links the time and place an enquiry is made, data relating to the position of the vehicle being investigated, (which will be explained further below), a reading of the position as given by the zone code, a record of a digital image of a registration plate of the vehicle, a record of the vehicle registration determined by image analysis, an indication of the unit which detected the vehicle and, if appropriate, an indication of the rule infringed or complied with. It is possible that a vehicle may infringe more than one rule by being improperly parked. Accordingly, the event database may allow for more than one rule to be logged in the rule infringed column or there may be a separate entry per rule infringed.

FIG. 9 is a schematic view of a penalty database. The penalty base links the date and time of an infringement, the zone in which the infringement occurred, the registration of the vehicle which infringes the rule, an indication of the rule infringed, an indication of a fine to be paid, an indication of the date on which action was taken, for example the date on which notification of the fine due was sent, an indication of the person whom the fine notification was sent and an indication of the date on which the fine was paid.

FIG. 10 is a schematic view of a purchase database for use in an apparatus according to the invention.

The purchase database links the date and time on which a purchase request was made, an identification of the user making the purchase request, an identification of the registration of the vehicle for which the parking request is made, an indication of the zone in which the vehicle is to be parked, comprising a zone code, an indication of the rules which govern parking in that zone, an indication of a sum paid for parking, and indication of the time period for which parking has been purchased and an indication of a time on which the vehicle leaves the location.

FIG. 11 is a schematic view of the steps involved in obtaining data for determining the position of a parked vehicle.

These are steps which as authorised user of a vehicle observing device according to FIG. 2 will take.

In step S101, the user switches the device on. In step S102, the user presents a coded key, which has an authorisation code encoded in a suitable manner, for example, as a magnetic code. In step S103, the device checks whether the authorisation code is correct. For example, the device may be set up so that it can only be used by a person with a single specified identification code, or an identification code selected from a specified list of acceptable codes. If the code is not correct, the user cannot obtain any function from the device. If the code is correct, the user checks the device status in step 104. For example, it may be necessary to check whether there is a strong enough radio signal to transmit data. It may be necessary to check the battery level. It may not be possible to use the device if a previous observation is still recorded in the memory. If there is problem, the user takes the necessary corrective action in step 105, for example moving into a zone which there is a signal, replacing the battery or transmitting or deleting data recorded in the memory. Once all of these steps have been taken, the device is ready to use (step 106) The user may then carry the device around until a vehicle is spotted which may be infringing a parking rule. While the device is carried around, it may be necessary for the key 1410 to be kept within a certain range of the device 1400 in order to allow the device to continue to operate. In this way, if the device is stolen, it cannot be operated unless the key has been stolen as well.

In step S107, the user spots the vehicle which may be infringing a rule and activates the device by pointing the device at the vehicle so that an image can be seen using the digital camera 1401. The device then proceeds to capture a digital image of a registration plate of the vehicle (step S108). In step S109, the range from the device 1400 to the vehicle is detected by the range finder 1402. In step S110, the compass direction of the line of sight joining the device 1400 and the vehicle is determined by the compass 1404 and the inclination to the horizontal of the line of sight joining the device 1400 and the vehicle is determined. In step S111, the GPS device 1409 determines the position of the device 1400 by analysing GPS signals received from GPS satellites. In step S112, the microprocessor determines if all of the required data (the image of the registration plate, the range, the direction, inclination and GPS reading) have been obtained correctly. If not, the device signals the user to repeat the process and try again. If the data has been correctly completed, the user is signalled to either store the data in the memory for transmission later or to transmit the data. In step S115, a signal comprising the data collected together with an identification of the authorised user is transmitted to the central apparatus 1110 or 1100 of FIG. 1 or 4. Optionally, the range, direction, inclination and GPS data can be combined to determine the location of the vehicle in GPS determined coordinates as will be described further below. This is carried out in step S113a.

FIG. 12 shows the steps involved in determining if parking rules are complied with by a vehicle. The process of FIG. 12 may be carried out in the apparatus of FIG. 4. Most of the steps in FIG. 12 will carried out in the parking infringement processor 1113 as will be made clear below.

In step S116, a signal is received from a signal transmitting unit. This may be any type of signal transmitting unit, including a vehicle observing device 1400 as shown in FIG. 2 or a parking information request unit 1500 as shown in FIG. 3. The signal received will contain a code identifying what type of unit has transmitted the signal. This code will indicate whether the signal transmitting unit is:
a) a purchase enquiry unit (see FIG. 14)
b) a vehicle observing device for determining if parking regulations are complied with, or
c) a vehicle observing unit for determining if highway regulations, for example red routes, are being complied with (see FIG. 13).
   In step S117, the preliminary processor 1111 of FIG. 4 determines which type of transmitting unit has made the request and directs the request accordingly. From step S117 onwards in FIG. 12, the process for determining if parking rules have been infringed as carried out in apparatus 1113 of FIG. 4 will be described.
   In step S118, the processor 1113 transmits an acknowledgement signal to the transmitting unit to indicate that the original signal has been received.
   In step S119, the enquiry data, comprising a digital image of the registration plate of the vehicle is analysed. Conventional imaging analysis means may be used to extract from the image the vehicle registration number.
   In step S120, the location data is processed. In order to do this, the satellite determined position of the vehicle observing device 1400 and the data representing the position of the vehicle being observed with respect to the vehicle observing device are processed to produce a position for the vehicle being observed in a satellite based coordinate system, which will be described further below. Step S120 may be omitted if location data has already been processed in step S113a as described above.

Optionally, where the central apparatus receives a satellite determined location from the transmitting unit, the raw satellite determined data for the transmitting unit may be corrected or adjusted using differential GPS processing technology or other resolution enhancing technology, as is known in the art.

Once the location has been determined, the processor checks in the zone database to see which zone the vehicle is in and what rules apply to that zone (step S121). Once the rules have been determined from the zone database, the infringement conditions are retrieved from the rule database as shown in FIG. 7 in step S122.

It is first of all determined in step S123 if the rule is a rule relating to a ticket, and absolute rule or a conditional rule. If the rule relates to a ticket, the processor checks in steps S124 and S125 in the purchase database 1133 if a ticket has been purchased by the vehicle whose registration number has been determined, for the location in which it is parked. If there is a valid ticket, the processor logs the event in the event database in step S126. If, however, there is not a valid ticket permitting parking in the location, a penalty is activated in the step S127 as will be described further below.

If is determined in step S123 that the rule is an absolute rule, it can then be determined in step S124 if the rule is infringed or if there is no infringement because the vehicle driver is a permitted user such as a doctor.

If it is infringed, a penalty is activated in step S127. If it is not infringed, the event is logged in the event database 1133 as shown in steps 126.

If it is determined in step S123 that the rule is conditional upon an earlier event, the processor will check the event database 1134 to see if the vehicle has been detected in the location before. For example, Rule R4 is infringed if the vehicle is parked at time T and at time T plus one hour or more. If the rule is infringed, a penalty is activated in step S127. If the rule is not infringed, the event is logged in step S126. Again, it may be determined that the vehicle driver is a permitted user such as a doctor and there is no infringement.

It is possible that, upon inspection of the rule database, no rule can be found for the zone in which the vehicle is parked. In this case, the system can proceed directly to step S126 and log the enquiry.

FIG. 13 shows the series of steps involved in determining if the vehicle infringes highway parking rules. The process shown in FIG. 13 continues from step S117 of FIG. 12. In step S130, a highway control event is notified to the highway control processor 1114 by the preliminary processor 1111. In step S131, the highway control processor transmits an acknowledgement of receipt of the enquiry to the transmitting unit. In step 132, the image data is processed as described above in relation to FIG. 12. In step S133, the location data is processed as described above in relation to FIG. 12 Step S133 may be omitted if location data has already been processed in step S113a above. In step S134, the processor 1114 will check the zone database of FIG. 5 to determine the rule which applies to the location of the vehicle. or if there is no infringement because the vehicle driver is a permitted user such as a doctor.

In step S135, the rule infringement conditions are retrieved from the rule database. In step S136, it is determined if the rule is absolute or conditional.

If it is determined that the rule is an absolute rule, for example if parking is not permitted at all or if parking is only permitted at certain times of the day, it is determined in step S137 if the rule is infringed, or if the vehicle is a vehicle driven by a permitted user such as a Doctor. If the rule is infringed, a penalty is activated in step S138 as will be described further below. When the penalty has been activated, the event is logged in step S139. Under some highway control systems, brief parking is permitted for example for unloading, in which case there is no infringement if a vehicle is observed parked in a location for a short period of time and then moves.

If there is no infringement, the event is logged in the event database 1143 in step S139. If it is determined that the rule is conditional, the processor 1114 will check in the event database 1143 to see if the vehicle has been detected in the zone at a previous point in time. If as a result of this check, it is determined that the rule is infringed in step S141, a penalty is activated in step S138 and subsequently logged in step S139. If there is no infringement, the enquiry is logged in step S139.

FIG. 14 shows the steps involved in making a parking rule enquiry, including the steps involved in purchasing a parking ticket. The process of FIG. 14 may be carried out in the processor 1112 of FIG. 4 following an enquiry from a unit 1500 according to FIG. 3. FIG. 14 continues from step S117 of FIG. 12. The signal transmitting unit 1500 is configured to include a code in a request signal to indicate whether the enquiry relates to a ticket purchase, a cancellation of an existing purchase a point enquiry or an area enquiry. In step S140, an enquiry is received by the processor 1112 from the preliminary processor 1111. In step S141, it is determined if the enquiry relates to the purchase of a parking ticket a cancellation or to a request for information about parking at a given point or to a request for information about parking in an area. If it is determined in step S141 that the enquiry relates to a cancellation of an existing purchase request or parking purchase, for example a manual cancellation by the user or a cancellation because a vehicle has moved, the cancellation is logged in step S1411. This will be described further below with relation to FIG. 16. If it is determined in step S141 that the enquiry relates to ticket purchase, the processors checks in step S142 for the zone and rules applicable to the coordinates represented by the signal received from the unit 1500. In step S142, the rule infringement conditions and parking fee are retrieved from the rule database.

In step S144, it is determined if the rule is absolute or conditional. If it is determined that the rule is absolute and that it is not necessary to check whether the vehicle has already been parked at the location, it is determined in step S145 if parking is allowed. For example, the parking time may be checked. If parking is not permitted, a signal is transmitted back to the preliminary processor 1111 and via the modem 1110 to the unit 1500 to indicate that parking is not permitted. However, if parking is permitted, parking information, including the period for which parking is permitted, the fee for parking and any other useful information is transmitted via the preliminary processor 1111 and modem 1110 to the unit 1500.

If it is determined in step S144 that the rule is conditional, the processor will check in step S147 in the purchase database 1125 whether the vehicle has already parked at the location within a specified period of time. It is then determined in step S147 if subsequent parking is permitted. If parking is not permitted, parking is rejected in step S149, and a signal is transmitted to the unit 150 indicating that parking is not permitted.

If parking is permitted, a signal is transmitted in step S150 to the unit, providing an indication that parking is permitted and an indication of the parking fee. In step S151, it is determined if a parking purchase signal has been received in reply to the parking information transmitted in step S150. If no parking purchase signal is received, the process terminates. If, however, a purchase signal received, the system proceeds to step S152. The purchase signal will comprise an indication that parking is requested, together with (optionally) an indication of the period of time for which parking is requested and a payment instruction. Alternatively, the system may be configured so that open-ended parking can be purchased. The parking purchase processor may be configured so that it charges the vehicle driver on the basis of the time for which the vehicle is parked. This system is particularly useful where a parking purchase enquiry unit has the capacity to give a signal indicating when the vehicle is moved, as described below in relation to FIG. 16. The parking purchase processor may comprise a time-out system whereby if purchase is not confirmed within a fixed period of time, the purchase enquiry is terminated and the user has to start again.

The payment instruction may comprise an instruction to debit an account held by the parking purchase processor 1112 or an instruction to debit a credit card account in a known manner. In step S153, it is determined if sufficient credit is available in the account database maintained by the processor or the credit card. If sufficient credit is not available, the request is rejected in step S149. If sufficient credit is available, the purchase of parking is logged in the purchase database 1123 and the account is debited in step S155. When this is complete, a notice is transmitted via the preliminary processor 1111 and modem 1110 to the purchaser indicating that parking is permitted in step S156. Finally, the processor 1112 is configured to send a signal to the parking infringement processor 1113 to indicate in the parking purchase database 1133 of that processor that parking has been purchased for a specified period of time.

If it is determined in step S141 that a point enquiry is being made, the processor will check in step S158 in the zone database corresponding to the coordinates of the transmitting unit to determine the zone and rules applicable. In step S159, a rule corresponding to the zone is retrieved and in step S160, the rule is transmitted to the transmitting unit.

The rule may be transmitted with a request for the purchaser to indicate whether they wish to purchase parking or not. The system is then directed to step S151 for the user to confirm purchase.

If it is determined in step S141 that an area enquiry is being made, for example if the enquirer wishes to know if parking is available within a specified distance of the transmitting unit, the processor first determines in step S162 which zones are to be investigated. For example, the processor may be configured to convert the coordinates of the transmitting unit in to a range of coordinates by adding a specified correction to give an upper limit and subtracting a specified correction to give a lower limit. In step S163, all the zones covered by the range of coordinates in the zone database are checked. In step S164, the relevant rules are retrieved and in step S165, it is determined where parking is allowed. In step S165, the purchaser may be configured to check the purchase database 1125 to determine where vehicles are already parked. In step S166 the information obtained is transmitted to unit 1500. Then the processor returns the process in step S161 to a step S141 to determine if the enquirer wishes to purchase parking.

Many tickets purchased for parking are subject to a time limit. The present invention can provide a system for transmitting a warning to the person who has purchased the ticket to indicate if their ticket is likely to expire soon. A suitable system is shown in FIG. 15. The process is carried out in the device for obtaining parking information S1500 of FIG. 3. In step S200, when the device receives a signal confirming that parking has been purchased (as in step S156 of FIG. 14), the device logs the ticket purchase, including the time T0 at which the ticket was purchased and the time T1 at which it will expire. In step S201, the microprocessor starts a timer. The microprocessor is configured to check in step S202 at regular time intervals of t in the ticket purchase log. In step S203, it is determined if the time T0+t exceeds the time T1. It is also determined if the car is still parked, in a manner which will be described with respect to FIG. 16 below.

If T0+t is not greater than T1, it is then determined in step S204 if the difference between T1 and (T0+t) is less than a specified figure, for example 10 minutes. If not, the system returns to step S202 to make a further check in the ticket purchase log at a time interval t. If however the difference is less than 10 minutes, the processor is configured to transmit an alert to the person who has parked the vehicle, in step S205. This alert may suitably be sent by triggering a text message to be sent to the person's mobile phone. Following step S205, the system returns to step S202 to make a regular check at suitable increments in time t. If however, it is determined in step S203 that T 0+t is greater than T1 and the car is still in the parking position, the microprocessor is configured to transmit an alarm, suitably via a text message, to the person who has parked the car to indicate that their parking has expired and they should come back and move the vehicle as soon as possible.

FIG. 16 shows the steps involved in notifying the central apparatus that a vehicle has moved. Where a ticket has been purchased which expires after given time, it is in the interests of the person who has parked the vehicle to notify to the central apparatus when they have moved to avoid any risk of incurring a penalty. The system may be configured so that the person driving the vehicle operates the unit 1500 to transmit a signal indicating that the vehicle has moved. However, FIG. 16 shows a system in which this can be carried out automatically.

In step S210, the microprocessor of the parking information device 1500 logs the purchase of the ticket at time T 0 on receipt of the signal from the purchase processor as shown in FIG. 14. At the same time, the microprocessor of the device 1500 makes a record of the satellite determined position of the vehicle in step S211. A timer is then started starting from T 0, the time at which the ticket was purchased (step S212). The microprocessor is configured to check at regular intervals of t whether the vehicle is moved. It will do this by determining the satellite determined coordinates of the vehicle and comparing them to the recorded coordinates. If they are different, the vehicle is deemed to have moved. In this case, the microprocessor is configured to transmit a signal to the apparatus to indicate that the vehicle has moved. In step S215, the signal that the vehicle has moved is received by the central apparatus. It is processed in step S216 by the preliminary processor 1111 and identified as a purchase enquiry. In step S217, the parking purchase processor 1112 will log the event in the parking event database 1124.

If at time T+t it was determined that the car had not moved, the timer is reset so that T=T 0+t and the system returns to step S212 to make a further check after an increment of time t. In this way, by checking at regular intervals, a signal can be sent shortly after the vehicle has moved.

FIG. 17 shows the steps involved in activating a penalty. These are the steps which will be triggered from step S127 of FIG. 12 or step S138 of FIG. 13. In step S300, the activate penalty signal is received by a penalty processor. In step S301, it is determined if the penalty is a type which is dealt with by the processor 1113 or 1114. If it is not a penalty of the type handled by the processor, a signal is transmitted to a penalty enforcement contractor in step S302. This signal suitably comprises an indication of date and time on which the infringement occurred, the vehicle registration, the rule infringed, the penalty to be incurred and an identification of the vehicle observation device which detected the infringement. Having transmitted the data, the event will be logged in step S303. If however, the penalty is of the type handled by the processor, it is necessary to first of all the check if the registration number of the vehicle is known already.

This may be determined for example by inspecting the account database or penalty database in step S304. This database is checked to see if contact details are available for the registration number of the vehicle which has been determined earlier. If contact information is available, it is determined in step S306 if the penalty comprises a fine or not. If the penalty comprises a fine, the system is configured to generate a fine notification. The fine notification will comprise an indication of the vehicle registration, the date and time on which the infringement was detected, the zone in which the vehicle was located and the rule infringed. The fine notice will be transmitted to the contact data determined from the account database.

In step S308, it is determined if further action is required, for example, it may be necessary to transmit a signal to an enforcement authority to remove the vehicle. This may particularly be the case in areas where parking is not permitted at all, to prevent traffic congestion. If further action is required, the further action is activated in step S309. If it is determined in step S306 that no fine is involved, it is determined in step S308 if alternative action is required.

After activating the appropriate action, the event is logged in a penalty database. Equally, if no action were required in step S308, the event is logged in the penalty database.

If it is determined in step S305 that contact data is not available, a registration enquiry may be transmitted to a vehicle registration authority 1740 as shown in FIG. 1.

The registration enquiry will comprise an identification of the vehicle registration number which is believed to have infringed a parking rule, together with an authorisation code identifying the processor making the enquiry. The authorisation code is required, because information relating to vehicle owners is generally maintained under conditions of confidentiality and only released to persons authorised to obtain the information. In step S312, the registration enquiry is received by the vehicle registration authority. In step S313, the vehicle registration authority determines registration data, in accordance with procedures which are standard in the art. For example, the registration data may comprise the vehicle registration number, the name of the vehicle owner, information about the type of vehicle and a contact address for the vehicle owner.

In step S314, the registration data is transmitted to the processor via the communication network 1200. The registration data will further comprise an indication of the processor 1113 or 1114 making the registration enquiry. The preliminary processor 1111 will determine which processor 1113 or 1114 to direct the registration data to, in step S215. The processor is then in a position to continue the process as described above from step S306.

FIG. 18 is a schematic diagram showing how the position of a vehicle may calculated in an apparatus according to the invention. FIG. 18 shows the processing which may be carried out in steps S113a of FIG. 11, S120 of FIG. 12 or S133 of FIG. 13.

In FIG. 18, the position D represents the position of the vehicle observation device. The triangle A B C is located in a horizontal plane which contains the location at which the vehicle is parked (A). The device may be located in position D which is above or below the plane containing the triangle A B C, but the calculations will be the same.

The following information will be determined by the vehicle observation device:

the inclination (angle X D A)

the range (distance A D)

the compass bearing of the vehicle from the vehicle observation device.

The inclination the line of sight from the vehicle observation device to the vehicle X D A will be the same as the angle of D A C of the right angled triangle A B C. From the range A D, and the angle of inclination, the length of the side of A C can be calculated by single trigonometry.

As the triangle A C B it is located in the horizontal plane containing the vehicle, the angle A C B can be determined suitably. It will either comprise the compass bearing itself or, as shown in FIG. 18, 360° minus the compass bearing. From this angle, and length of the side A C, the distances C B and AB can be calculated. A C is the north correction for the satellite determined position D of the vehicle observation device required to give the North position of the vehicle. A B is the West correction required to give the West position of the vehicle.

The processing apparatus described above can comprise dedicated hardware or programmable hardware or even a combination. The programmable hardware can comprise any suitable programmable device such as general purpose computer. In order to configure the programmable device to operate in accordance with the invention, suitable programme code can be provided to the device using any conventional carrier medium, e.g. floppy disk, CD-ROM, tape device, or programmable logic device or a transient carrier medium e.g. electrical, a optical, microwave or radio frequency signal. An example of the application of a transient signal is the downloading of programme code over a network e.g. the internet.

The present invention has been described above by way of example only and modifications can be made within the invention. The invention extends to equivalents of the features described.

In particular, the preferred embodiment has been described above with reference to the use of satellite determined coordinates. Any method of distant-reference determined coordinates may be used in an exactly equivalent way, in a manner which will be clear to the person skilled in the art. The methods of pseudo-satellite coordinate determination or INS coordinate determination may be used instead of satellite determination or to supplement it.

1. Apparatus for determining compliance with parking rules by a vehicle, comprising:
means for receiving an enquiry signal representing a location selected from a plurality of locations, rule storage means for storing parking rules relating to the plurality of locations, means for obtaining from the rule storage means a rule relating to the selected location, means for determining if a vehicle parked at the selected location complies with the rule, and means for transmitting a compliance signal representing the compliance determination.

2. Apparatus according to claim 1, wherein the signal receiving means is a wireless signal receiving means.

3. Apparatus according to claim 1 or 2, wherein the signal receiving means is configured to receive a signal comprising an identification of a signal transmitting unit.

4. Apparatus according to claim 3, wherein the signal transmitting means is configured to transmit the compliance signal to the signal transmitting unit.

5. Apparatus according to claim 3 or 4, further comprising compliance storage means, the apparatus being configured to record the compliance determination and the identification of the transmitting unit in the compliance storage means.

6. Apparatus according to claim 3 or 5, wherein the identification of the signal transmitting unit is a secure identification.

7. Apparatus according to claim 3, wherein the identification of the signal transmitting unit further comprises an identification of signal transmitting unit type or enquiry type, the apparatus comprising separate compliance determining means for different unit types and means for directing a signal to the compliance determining means appropriate to the type of transmitting unit.

8. Apparatus according to claim 7, wherein selected separate compliance determining means cannot communicate with one another.

9. Apparatus according to any preceding claim, wherein the signal representing a selected location comprises distant-reference determined coordinates.

10. Apparatus according to claim 9, wherein the signal representing a selected location comprises distant-reference determined coordinates of a vehicle observing unit and coordinates representing the position of the vehicle with respect to the vehicle observing unit.

11. Apparatus according to claim 11, wherein the coordinates representing the position of the vehicle with respect to the vehicle observing unit comprise the distance of the vehicle from the observing unit, the inclination to the horizontal of the line joining the vehicle and the observing unit and the compass bearing of the line joining the vehicle and the observing unit.

12. Apparatus according to any of claims 1-9, being for receiving an enquiry signal from a parking purchase unit, the means for determining if the vehicle parked at the selected location complies with the rule further comprising means for determining a parking fee to be paid for compliance to occur, the compliance signal further comprising an indication of the fee to be paid, the apparatus further comprising fee payment means for receiving payment of a fee from the parking purchase enquiry unit and for transmitting a further compliance signal to the paring purchase unit when the parking has been successfully purchased.

13. A system for determining compliance with parking rules by vehicle, comprising: a plurality of transmitting units for transmitting enquiry signals representing a location selected from a plurality of locations, an apparatus comprising means for receiving an enquiry from a transmitting unit, rule storage means for storing parking rules relating to the plurality of locations, means for obtaining in response to an enquiry signal from a transmitting unit a rule relating to the respective selected location from the rule storage means, means for determining if the rule is infringed by a vehicle parked at the respective selected location complies with the rule, and means for transmitting a compliance signal representing the compliance determination.

14. A system according to claim 13, wherein the transmitting unit is a wireless signal transmitting unit and the signal receiving means is a wireless signal receiving means.

15. A system according to claim 13 or 14, wherein the transmitting unit is configured to transmit a signal comprising an identification of a signal transmitting unit.

16. A system according to claim 15, wherein the signal transmitting means is configured to transmit the compliance signal to the signal transmitting unit.

17. A system according to claim 15 or 16, further comprising compliance storage means, the apparatus being configured to record the compliance determination and the identification of the transmitting unit in the compliance storage means.

18. A system according to claim 15 or 17, wherein the identification of the signal transmitting unit is a secure identification.

19. A system according to claim 15, wherein the identification of the signal transmitting unit further comprises an identification of signal transmitting unit type, the apparatus comprising separate compliance determining means for different unit types and means for directing a signal to the compliance determining means appropriate to the type of transmitting unit.

20. A system according to claim 19, wherein selected separate compliance determining means cannot communicate with one another.

21. A system according to any of claims 13 to 20, wherein the signal representing a selected location comprises distant-reference determined coordinates.

22. A system according to claim 21, wherein the signal representing a selected location comprises distant-reference determined coordinates of a vehicle observing unit and coordinates representing the position of the vehicle with respect to the vehicle observing unit.

23. A system according to claim 22, wherein the coordinates representing the position of the vehicle with respect to the vehicle observing unit comprise the distance of the vehicle from the observing unit, the inclination to the horizontal of the line joining the vehicle and the observing unit and the compass bearing of the line joining the vehicle and the observing unit.

24. A system according to any of claims 13-21, wherein the apparatus is for receiving an enquiry signal from a parking purchase unit, the means for determining if the vehicle parked at the selected location complies with the rule further comprising means for determining a parking fee to be paid for compliance to occur, the compliance signal further comprising an indication of the fee to be paid, the apparatus further comprising fee payment means for receiving a payment instruction from the parking purchase unit and for transmitting a further compliance signal to the parking purchase unit when the parking has been successfully purchased.

25. A mobile vehicle observing means for providing data for determining the position of a parked vehicle, comprising:
camera means for obtaining a digital image of at least the registration plate of the vehicle,
position detecting means, for detecting the position of the mobile device,
range determining means for finding the range of the vehicle from the mobile device,
direction determining means for finding the direction of the vehicle with respect to the mobile device, and
transmitting means for transmitting signals representing the image of the vehicle, and the direction and distance of the vehicle from the mobile device to an apparatus.

26. The mobile vehicle observing means according to claim 25, further comprising means for transmitting an identification of the mobile vehicle observing means to the apparatus.

27. The mobile vehicle observing means of claim 25 or 26, wherein the transmitting means is a wireless transmitting means.

28. The mobile vehicle observing means of any of claims 25 to 27, further comprising user identification means for identifying a user of the mobile vehicle observing means.

29. A device for obtaining parking information for a vehicle, the device being mountable in a vehicle and comprising:
means for determining the position of the vehicle,
transmitting means for transmitting a request to an apparatus, the request comprising an identification of the vehicle position, and a request identification,
receiving means for receiving a parking rule from the apparatus, and
means for displaying the parking rule.

30. A device for obtaining parking information according to claim 29, further comprising means for receiving from the apparatus an indication as to whether parking is permitted and a request for payment of a parking fee, means for transmitting a payment instruction to the apparatus and means for receiving from the apparatus confirmation that the fee has been paid.

31. A parking rule compliance determiner, for determining compliance with parking rules by a vehicle, comprising:
a receiver connecting the determiner with a first transmitter for transfer of data representing a location selected from a plurality of locations,
a rule storage device for storing parking rules relating to the plurality of locations,
a processor programmed to:
obtain from the rule storage device a rule relating to the selected location, and
determine if a vehicle parked at the selected location complies with the rule, and
a second transmitter for transmitting a compliance signal representing the compliance determination.

32. The parking rule compliance determiner of claim 31, wherein the receiver is connected to the first transmitter by a wireless link.

33. The parking rule compliance determiner of claim 31, wherein the data transferred further comprises the satellite determined position of the first transmitter, the distance of the vehicle from the first transmitter, the inclination to the horizontal of the line joining the vehicle and the first transmitter and the compass bearing of the line joining the vehicle and the first transmitter, the processor being further programmed to determine the position of the vehicle from the data.

34. The parking rule compliance determiner of claim 31, wherein the receiver is configured to receive a parking purchase request from the first transmitter, the processor being further configured to process the parking purchase request.

36. A mobile vehicle observer for providing data for determining the position of a parked vehicle, comprising:
a camera for obtaining a digital image of at least the registration plate of the vehicle,
a position detector, for detecting the position of the mobile device,
a range determiner for finding the range of the vehicle from the mobile device,
a direction determiner for finding the direction of the vehicle with respect to the mobile device, and
a transmitter for transmitting signals representing the image of the vehicle, and the direction and distance of the vehicle from the mobile device to an apparatus.

37. A device for obtaining parking information for a vehicle, the device being mountable in a vehicle and comprising:
a position determiner, for determining the position of the vehicle,
a transmitter for transmitting a request to an apparatus, the request comprising an identification of the vehicle position, and a request identification,
a receiver for receiving a parking rule from the apparatus, and
a display for displaying the parking rule.

38. A process for determining compliance with parking rules by a vehicle, comprising:
receiving an enquiry signal representing a location selected from a plurality of locations, obtaining from rule storage means for storing parking rules relating to the plurality of locations, a rule relating to the selected location, determining if a vehicle parked at the selected location complies with the rule, and transmitting a compliance signal representing the compliance determination.

39. An apparatus for providing information about compliance with parking rules by a vehicle, comprising means for receiving an enquiry signal from an enquiry unit, the signal representing a location selected from a plurality of locations, rule storage means for storing parking rules relating to the plurality of locations, means for obtaining from the rule storage means a rule relating to the selected location and means for transmitting a signal representing information about the parking rule to the enquiry unit.
